(19) United States
(12) Patent Application Publication
(10) Pub. No.: US 2023/0356572 A1
(43) Pub. Date: Nov. 9, 2023

(54) STRUCTURAL MODULE HAVING FRANGIBLE EXTENSION MEMBER

(71) Applicant: Magna Closures Inc., Newmarket (CA)

(72) Inventor: Mirko Iannone, Pisa (IT)

(21) Appl. No.: 18/132,484

(22) Filed: Apr. 10, 2023

Related U.S. Application Data
(60) Provisional application No. 63/337,747, filed on May 3, 2022.

(51) Int. Cl. B60J 5/04; B60N 2/75

(52) U.S. Cl. CPC B60J 5/0461; B60J 5/0418; B60J 5/0455; B60N 2/78

(57) ABSTRACT

A structural door module for a motor vehicle door includes a carrier plate with a dryside and wetside surface configured for mounting components thereto. The carrier plate includes an extension member projecting inwardly toward the vehicle interior. A frangible connection seam is disposed at least partially around the interface between the extension member and the carrier plate. In response to a side impact load, the carrier plate moves inwardly, and the frangible connection seam at least partially severs. The carrier plate moves inwardly relative to the extension member, limiting intrusion of the extension member into the passenger compartment.

### CROSS-REFERENCE TO RELATED APPLICATIONS

This application claims the benefit of previously filed U.S. Provisional Patent Application No. 63/337,747, filed May 3, 2022, titled “STRUCTURAL MODULE HAVING FRANGIBLE EXTENSION MEMBER,” the entire content of which is hereby incorporated by reference in its entirety.

### FIELD OF THE INVENTION

The present invention relates to a module for a motor vehicle closure panel. More particularly, the present invention relates to a structural module that strengthens the motor vehicle door body and acts as a hardware carrier for hardware subsystems and reduces intrusion into the passenger compartment during a vehicle crash event.

### BACKGROUND OF THE INVENTION

A motor vehicle closure panel typically includes an outer sheet metal panel, an inner sheet metal panel, and a plurality of hardware components mounted within an inner cavity formed between the outer and inner sheet metal panels. Common hardware components mounted to a door body include inner and outer door handle assemblies, window regulators, latch assemblies, and speaker assemblies, along with their ancillary connecting and electrical components. The complete assembly of the door involves multiple manufacturing steps and numerous parts. Conventionally, an original equipment manufacturer (OEM) will install each individual hardware component to the structural door body along an assembly line.

In general, vehicle occupants are less protected against side-impact collisions than front or rear-end collisions due to the relative thinness of the motor vehicle door. The door body itself can be forced into the passenger compartment, since the door body typically absorbs only a limited portion of the collision energy. Additionally, rigid hardware components that are mounted between the outer and inner sheet metal panels can also be forced into the passenger compartment. To improve safety in side-impact collisions, the vehicle door is typically reinforced by strengthening the sheet metal panels, or by mounting reinforcing structures such as crash beams to the door body. Additionally, one or more energy absorbing foam blocks are typically mounted between the inner and outer sheet metal panels to reduce the severity of a side-impact collision.

The conventional installation of the hardware and safety components has, however, several drawbacks. First, a high assembly cycle is required to assemble the door in this fashion because installation of each hardware and safety component is a separate task requiring human effort. Hardware components must be mounted to the door body and then interconnected. Second, operability of the hardware components cannot be determined until the respective components are installed onto the door. Thus, time and labor may be wasted installing inoperable or ill-fitted components. Finally, additional time is required to inventory each hardware component as it arrives at the OEM to ensure that all of the hardware components are available for assembly.

Pre-assembled door modules have been proposed to overcome some of the deficiencies of conventional door assembly methods. A door module typically involves using a carrier plate to partially assembly and orient hardware components thereto prior to installation to the structural door body. One disadvantage associated with such door modules is that once the door module is installed to the door, the carrier body typically serves little or no purpose because all of the hardware components are eventually securely fastened to the structural door body, and the door module itself does little or nothing to strengthen the door body. Another disadvantage associated with such door modules is that the door modules themselves are very labor intensive and require a large number of parts and steps to assemble before they can be delivered to the OEM.

It is therefore desired to provide a door module that adds structural support to a motor vehicle door body, provides greater protection to passengers, and is easy to assemble at an OEM plant.

### SUMMARY OF THE INVENTION

According to an aspect of the present disclosure, there is provided a structural door module for a motor vehicle door body. The structural door module includes a carrier plate forming a first (dryside) and second (wetside) surface, and a plurality of door hardware components are mounted to at least one of the first and second surface in a pre-configured orientation. The structural door module also includes an arm rest support that is integrally formed from and extends out from the first surface of the carrier plate.

The present disclosure provides a structural door module for a motor vehicle door body, comprising a carrier plate with a plurality of door hardware components mounted to the dryside and wetside surfaces of the carrier plate. The carrier plate may include a number of preformed components that allow door subsystems to be pre-mounted to the door module and tested prior to mounting the structural door module in the motor vehicle door body. Additionally, an extension member, for example in the form of an arm rest support, is designed to be at least partially frangible during a side-impact collision.

In one aspect, a structural door module for a motor vehicle closure panel is provided, including: a carrier plate including a dryside surface facing an interior of the motor vehicle and an opposed wetside surface facing an exterior of the motor vehicle; an extension member integrally formed with the carrier plate and projecting outwardly from the carrier plate and toward a passenger compartment of the motor vehicle; and a frangible connection seam extending at least partially around an interface between the extension member and the carrier plate; wherein the connection seam severs relative to the carrier plate in response to an impact load exerted toward the interior of the vehicle on the carrier plate.

In one aspect, the connection seam extends fully around the interface, and the extension member separates fully from the carrier plate in response to the impact load.

In one aspect, the connection seam extends partially around the interface, and a retaining section of the interface extends between opposite ends of the connection seam, and the extension member separates partially from the carrier plate and pivots about the retaining section relative to the carrier plate in response to the impact load.

In one aspect, the connection seam is defined by a reduced material thickness relative to the carrier plate.

In one aspect, the connection seam defines a flat interface that is orthogonal to the impact load when the impact load is directed toward the interior of the vehicle.

In one aspect, the retaining section is disposed along an upper edge of the extension member and the connections seam extends along a bottom edge and lateral edges of the extension member.

In one aspect, the connection seam has a reduced material thickness relative to the retaining section.

In one aspect, the extension member includes two arm rest supports each having the connection seam.

In one aspect, the extension member is configured to retain its shape in response to severing the connection seam, wherein the carrier plate moves inwardly relative to the retained shape of the extension member in response to the impact load.

In another aspect, a method of limiting inward intrusion by a structural module of a vehicle closure panel during a side impact is provided, the method including the steps of: providing a structural module having an extension member integrally formed with and projecting from a carrier plate; providing a frangible connection seam disposed around at least a portion of an interface between the carrier plate and the extension member; receiving an impact load at the carrier plate directed inwardly; in response to receiving the impact load, shifting the carrier plate inwardly and at least partially severing the frangible connection seam.

In one aspect, the method includes maintaining a connection between the extension member and the carrier plate along a retaining section therebetween in response to shifting the carrier plate inwardly.

In one aspect, the frangible connection seam extends around the interface and includes first and second ends, wherein the retaining section extends between the first and second ends, wherein the extension member bends relative to the carrier plate about the retaining section in response to the carrier plate shifting inwardly.

In one aspect, the frangible connection seam defines a closed loop around the interface, the method including fully severing the extension member relative to the carrier plate in response to shifting the carrier plate inwardly.

In one aspect, at least a portion of the extension member remains attached to an interior trim component in response to the carrier plate shifting inwardly.

In one aspect, the carrier plate defines an aperture, wherein the extension member encloses the aperture prior to receiving the impact load, wherein at least a portion of the extension member translates through the aperture in response to receiving the impact load.

In one aspect, the method includes severing a reduced material thickness along the connection seam in response to receiving the impact load, wherein the extension member shifts relative to the carrier plate in areas corresponding to the reduced material thickness.

In another aspect, a structural door module for a motor vehicle closure panel is provided, comprising: a carrier plate including a dryside surface facing an interior of the motor vehicle and an opposed wetside surface facing an exterior of the motor vehicle; an extension member integrally formed with the carrier plate and projecting outwardly from the carrier plate and toward a passenger compartment of the motor vehicle; an aperture formed in the carrier plate and enclosed by the extension member along an interface between the extension member and the carrier plate; wherein at least a portion of the interface has a reduced material thickness relative to the carrier plate; wherein the extension member severs relative to the carrier plate along the reduced material thickness of the interface in response to an inwardly directed impact load exerted on the carrier plate.

In one aspect, the reduced material thickness extends fully around the interface to define a closed loop, wherein the extension member fully severs relative to the carrier plate.

In one aspect, the reduced material thickness extends along a first portion of the interface, and a retaining section extends along a second portion of the interface, wherein the second portion of the interface has a greater thickness than the first portion of the interface, wherein the first portion severs and the second portion retains the extension member to the carrier plate in response to the impact load.

In one aspect, the extension member is fixed to an interior trim component, wherein the carrier plate shifts inwardly relative to the interior trim component and the extension member in response to the impact load.

### BRIEF DESCRIPTION OF THE DRAWINGS

Preferred embodiments of the present invention will now be described, by way of example only, with reference to the attached Figures, wherein:

FIG. 1 is a side view of a vehicle having a structural module disposed in an interior space of a vehicle closure panel;

FIG. 2 is a perspective view of the closure panel in an open position and providing access to the passenger compartment, and illustrating a vehicle trim component in the form of an arm rest supported by the structural module;

FIG. 3 is an exploded perspective view of a dryside of the structural door module;

FIG. 4 is a partial cross-sectional perspective view of a carrier plate of the module and an extension member in the form of an arm rest support supporting a pull cup of the arm rest;

FIG. 5 is a perspective view of the arm rest support having a frangible connection seam at an interface with the carrier plate;

FIG. 6 is a view of the wetside of the carrier plate and the extension member and illustrating a partial frangible connection seam;

FIG. 7 is a perspective view of the dryside of a single extension member projecting from the carrier plate and having a frangible connection seam fully surrounding the base of the extension member;

FIG. 8 is a perspective view of the wetside side of a single extension member projecting from the carrier, and having a frangible connection seam partially surrounding the base of the extension member;

FIG. 9 is a schematic cross-section view of the module within the interior space of the closure panel and prior to a side impact;

FIG. 10 is a schematic cross-section view of the module having shifting inwardly in response to a side impact and the extension member severing relative to the carrier plate;

FIG. 11 is a schematic view of the arm rest support and carrier plate with a full connection seam prior to a side impact;

FIG. 12 is a schematic view of the arm rest support and carrier plate with a full connection seam after a side impact;

FIG. 13 is a schematic view of the arm rest support and carrier plate with a partial connection seam prior to a side impact;

FIG. 14 is a schematic view of the arm rest support and carrier plate with a partial connection seam after a side impact;

FIG. 15 is a schematic view of a method in accordance with an aspect of the present disclosure;

FIG. 16 is a schematic view of a method in accordance with an aspect of the present disclosure;

FIG. 17 is a schematic view of a method in accordance with an aspect of the present disclosure; and

FIG. 18 is a schematic view of a method in accordance with an aspect of the present disclosure.

### DETAILED DESCRIPTION OF THE INVENTION

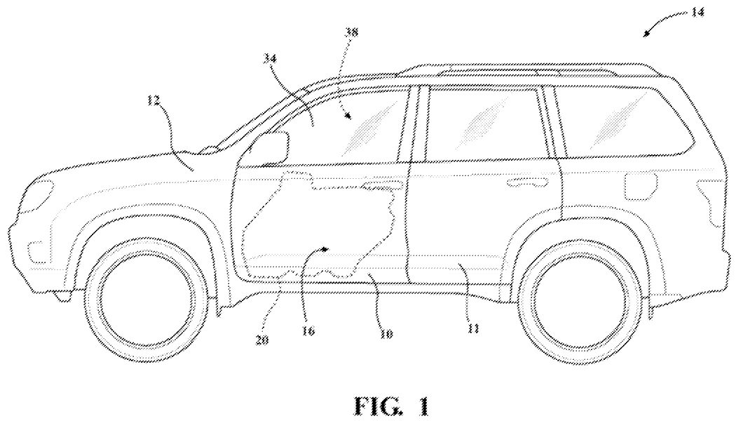

FIG. 1 is side view of a vehicle 14 having a vehicle body 12 defining at least one opening 38 that can be selectively closed via closure panels 10, 11, as shown in the form of a vehicle doors. The closure panels 10, 11 each define an interior space 16, in which a structural door module 20 may be disposed. The structural door module 20 is configured to support a variety of components within the interior space 16 of the closure panels 10, 11. For example, window regulator components configured for raising and lowered a window pane 34 may be attached to the structural door module 20. The structural door module 20 is shown in broken line in FIG. 1.

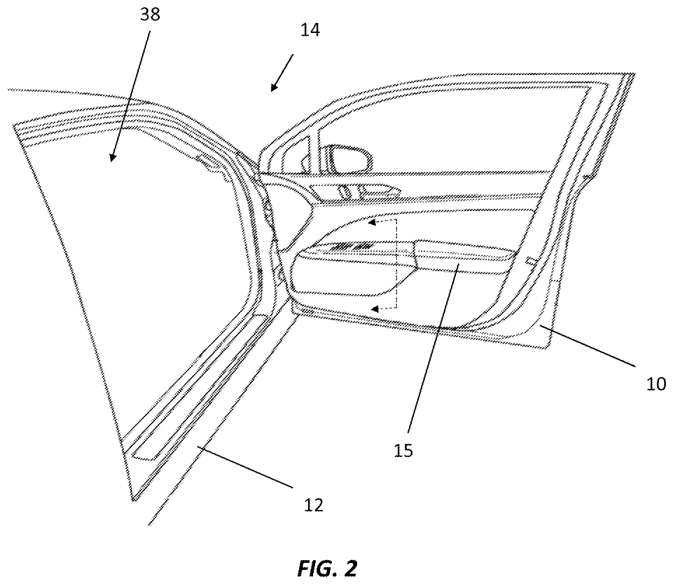

FIG. 2 illustrates the closure panel 10 in an open position, illustrating an interior vehicle trim component in the form of an arm rest 15. The arm rest 15 may be supported by the structural door module 20 disposed within the interior space 16 of the vehicle door. For example, projecting structure may extend toward the interior of the vehicle, with the arm rest 15 being attached to the projecting structure.

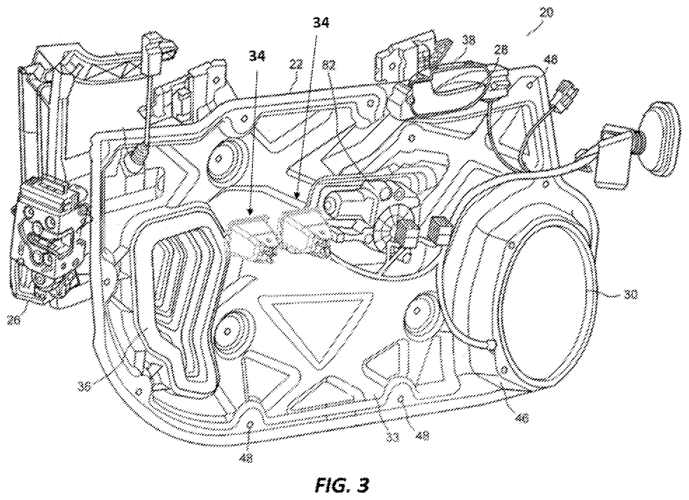

FIG. 3 show structural door module 20 in more detail, which includes a plurality of hardware subsystems mounted to or otherwise integrated with a carrier plate 22, and discussed in greater detail below. Carrier plate 22 provides opposing first and second surfaces, hereafter referred to as the “dryside” and “wetside” surfaces respectively. Shown in FIG. 3, the dryside surface of carrier plate 22 is visible in FIG. 3 and faces the interior of the vehicle when mounted to motor vehicle door 10. Conversely, the wetside surface of carrier plate 22 is not visible in FIG. 3 and faces the exterior of the vehicle when mounted to motor vehicle door 10. Hardware subsystems that may be typically pre-mounted to carrier plate 22 include a window regulator assembly, a latch assembly 26, a handle assembly 28, a speaker assembly 30, and an electrical harness assembly.

Carrier plate 22 may include a number of integrally formed or molded components. Integrally formed components on carrier plate 22, as shown in FIG. 3, include support ribs 33, an integral extension member 34 (in the form of arm rest support 34), at least one integral energy absorption block 36, an integral inner handle support 38, an integral latch presenter 42, and a speaker housing 46. It will be appreciated that the carrier plate 22 may be configured to support more or fewer components than those shown and described herein, such as those shown and described in U.S. Pat. No. 8,763,308, which is hereby incorporated by reference in its entirety. A plurality of fastener holes 48 spaced apart around the surface of carrier plate 22 provide a means to attach the structural carrier plate 22 to the motor vehicle door body through the use of carriage bolts, screws or the like. A water-sealing bead may be formed around the perimeter of carrier plate 22 on the wetside surface. The sealing bead engages the inner wall of the motor vehicle door body, providing a watertight seal for structural door module 20. The water sealing bead can be integrally formed from carrier plate 22 or, alternatively, water sealing bead can be affixed to carrier plate 22 as a foam adhesive or the like.

Carrier plate 22 is preferably manufactured from a composite material and molded into the desired shape. In the preferred embodiment, carrier plate 22 is manufactured using a 30% polypropylene matrix with glass reinforcement fibers. Other matrix materials will occur to those of skill in the art. Other reinforcement fibers contemplated include Kevlar, carbon fibers, and hemp, and other reinforcement materials will occur to those of skill in the art. As used herein, portions and/or features described as being integral with the carrier plate are formed as part of the molding process, which is to be distinguished from separate components that are then later fixed or attached to the formed/molded carrier plate 22. Put another way, the integral components may be part of a one-piece or single piece structure. Such a one-piece structure may be homogenous, or may be in the form of multi-shot molding where different materials are molded and formed together to define a generally fixed structure. For instance while the arm rest 15 may be attached and fixedly secured to the carrier plate 20, these components are not “integral.” The arm rest supports 34 projecting from the carrier plate 20, however, are “integral.” However, as discussed further, even with an integrally formed component, portions of the component could separate in response to an impact of other force applied to the integrally formed structure. This ability for a portion to separate is distinguishable from separately attached components that are designed to be formed separately and then attached together.

The support ribs 33 are a series of integrally formed ridges that traverse portions of the dryside and wetside surfaces of carrier plate 22, thereby reinforcing carrier plate 22. The inherent material strength of the composite material used in carrier plate 22 combined with support ribs 33 reinforces door module 20, and thus strengthens the motor vehicle door body when mounted thereto.

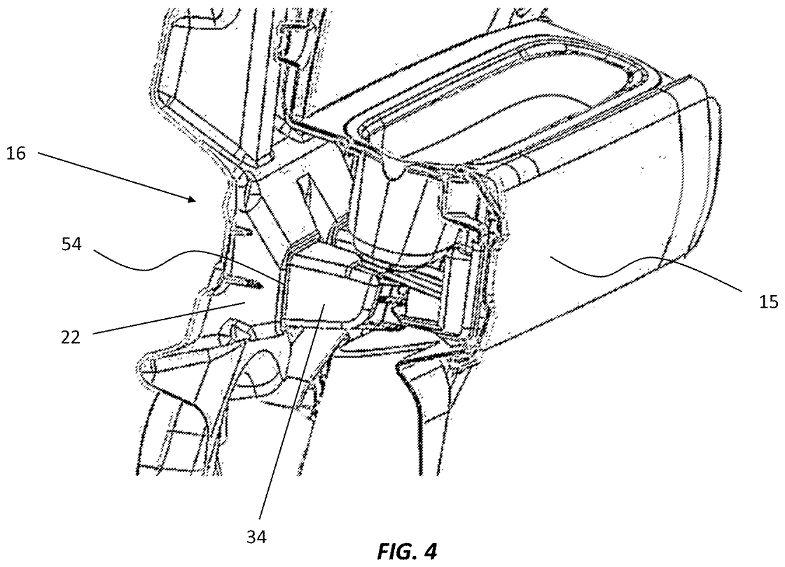

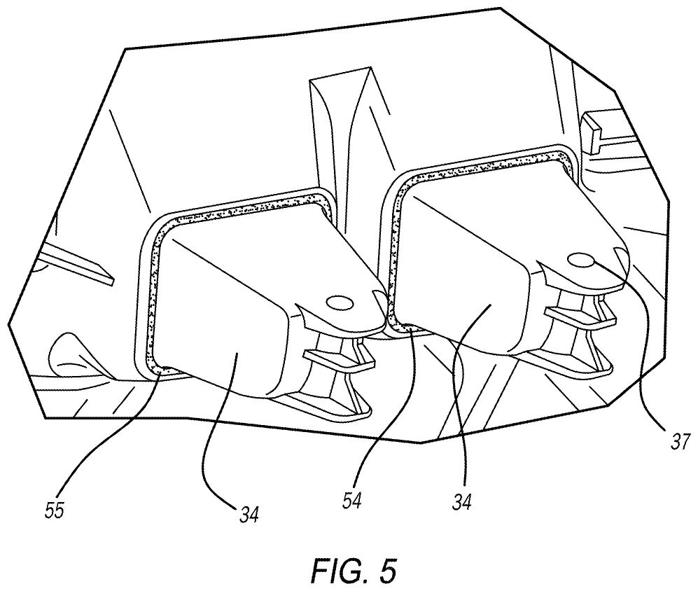

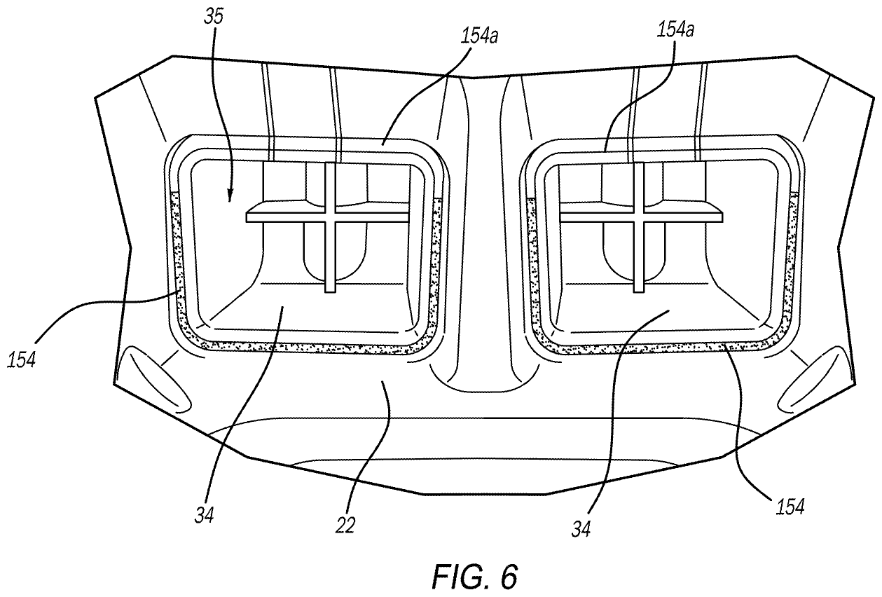

Referring additionally to FIGS. 4 and 5, arm rest supports 34 are shown in greater detail. As shown in FIG. 4, two arm rest supports 34 are illustrated generally side-by-side (the second support is partially visible behind the cup pull portions of the arm rest support 15); however a single arm rest support 34 could also be used. For the purposes a discussion, one of the arm rest supports 34 will be referenced, and it will be appreciated that reference to the arm rest support 34 is also applicable to additional similar structure. Arm rest support 34 is integrally formed with the carrier plate 22 and projects outwards generally perpendicularly from the dryside toward the interior of the vehicle, forming an arm rest hollow 35 on the corresponding and opposite wetside surface (see FIG. 6) of carrier plate 22. Arm rest support 34 is configured to mount a piece of armrest trim 15 (see FIG. 4) on the interior side of the motor vehicle door body. At least one fastener hole 37 is provided on the arm rest support 34 to secure the arm rest trim using a conventional fastener such as a screw, bolt or the like. The exact shape of arm rest support 34 (and number of supports) can vary in order to accommodate differently shaped pieces of trim. For example, as mentioned above, though the current embodiment uses two arm rest supports 34, it is contemplated that carrier plate 22 could provide one, three, or more arm rest supports 34 to mount a piece of arm rest trim.

During a side-impact collision, arm rest support 34 is designed to be frangible relative to the carrier plate 22. Put another way, the arm rest support 34 is configured to sever or break from the carrier plate 22, at least partially, such that the carrier plate 22 may shift inwardly relative to the vehicle door 10 (having the arm rest 34 support attached for example with a fastener or the like) while the arm rest support 34 does not substantially intrude into the passenger compartment. The arm rest 15 and the supports 34 may instead remain generally in place while the outer components move inwardly.

As can be seen clearly in FIGS. 4 and 5, a connection seam 54 is provided at the interface 55 between the arm rest support 34 and the carrier plate 22. The interface 55 may be in the form of a generally flat area that surrounds the base of the arm rest support 34. This flat interface 55 may include the seam 54, which may extend fully around the base of the arm rest support 34 in the form of a closed loop. The seam 54 may have a reduced material thickness relative to the remainder of the flat interface 55. The perimeter or path of the seam 54, accordingly, may define a common plane or exist in a common plane to define the flat area/interface 55 or correspond to the flat area/interface 55. It is understood that the severable seam 54 may be selectively provided at other locations of the carrier plate 22 and/or at interfaces with other features of the carrier plate 22 so as to provide a deliberate predetermined preferred zone of severability in the carrier plate 22.

In one aspect, the seam 54 may have a thickness of 1.0 mm, and the remainder of the flat area (or directly adjacent areas) may be 2 mm. Other relative thicknesses may be chosen depending on the size and arrangement of the carrier plate 22 and the arrangement of the arm rest 15 or trim that is supported by the arm rest support 34. The thickness of the seam 54 may be chosen such that the arm rest support 34 may sufficiently support the arm rest and be resistant to downward forces (from the weight of the arm, for example) during normal vehicle use, but still thin enough that during increased stress and loading caused by a crash event, such as a side impact event, the seam 54 will break or sever relative to the carrier plate 22, which itself receives the force of impact and shifts inwardly.

The flat interface 55 may be entirely comprised of the seam 54, such that the carrier plate 22 and the arm rest support 34 transition directly into the seam 54. Put another way, a curved transition portion of the arm rest support 34 may extend into the seam 54, and the seam 54 may then transition into a curved transition portion of the carrier plate 22. In another aspect, the curved transitions on either side of the seam 54 may transition into a straight or flat section on one or both sides of the seam 54. These curved transitions, whether leading directly to the seam 54 or leading to a flat portion on either side of the seam 54, may have a greater thickness that the seam as described above, thereby defining a reduced thickness along the seam that provides less resistance to an impact force and that thereby will sever or break in response to such a force while the surrounding structure remains thick enough to withstand such force.

The arrangement of the seam 54 is such that the seam 54 is part of the flat area that is orthogonal to the load direction during a side impact. Accordingly, the side impact load direction will have a reduced counter-acting reaction force vector from the arm rest support 34. However, it will be appreciated that the seam 54 will inherently provide a modicum of resistance opposite the inwardly directed force vector during a crash impact. Due to the reduced thickness of the seam 54 and the reduction or lack of a substantial reaction force at the location of the seam 54, the seam 54 will break or sever prior to a substantial loading of the arm rest support 34 or the surrounding area, such that after the seam 54 breaks, the arm rest support 34 will no longer receive a load (or will receive a reduced load) from the carrier plate 22 as the carrier plate is being impacted, and the arm rest support 34 will thereby be limited from intruding inwardly into the passenger compartment.

The above description of the seam 54 includes a seam 54 that extends fully around the base of the arm rest support 34, such that the arm rest support may be completely frangible from the carrier plate 22 when the carrier plate 22 receives a side impact. However, even with the seam 34 defining a full closed loop, the direction and/or force of the impact may still result in partial severing or breaking, such that a portion of the support 34 remains integral with the carrier plate 22. In another aspect, the arm rest support 34 is only partially surrounded by a frangible section. In such an arrangement, the seam 54 does not form an entire closed loop. Rather, the seam 54 may be formed to leave a thicker portion to define hinge-type structure, for example a U-shape. The thicker portion may simply be the same material thickness as the surrounding structure, or may be only a slightly reduced thickness, with the seam 34 being defined by the U-shape having the full reduced thickness that is thinner than the slightly reduced thickness. Thus, the full reduced thickness along the U-shape will sever or break prior to the hinge-portion, and a bending or pivoting movement of the carrier plate about the hinge portion may occur, with the arm rest support 34 again remaining generally stationary. This type of arrangement is described in further detail below with reference to FIG. 6.

With reference to FIG. 6, in another aspect a connection seam 154 extends partially around the base of the arm rest support 34. More particularly, the connection seam 154 extends around the bottom and lateral sides of the arm rest support 34. A retaining section 154a extends between the terminal ends of the connection seam 154 to complete the loop around the base of the arm rest support 34. The retaining section 154a has a thickness that is greater than the connection seam 154. The connection seam 154 may have a thickness similar to connection seam 54 described above, such that connection seam 154 will break or sever in response to a side impact load imparted on the carrier plate 22. While the connection seam 154 will break, the retaining section 154a will bend, such that the arm rest support 34 will pivot downwardly about the retaining section 154a in response to inward movement of the carrier plate 22, thereby limiting inward intrusion of the arm rest support 34 into the passenger compartment. In a situation where the arm rest support 34 does not pivot downwardly and instead remains generally stationary, the carrier plate 22 may pivot such that the bottom of the plate 22 moves inward and upward, and the top of the plate 22 moves outward and downward. Such movement applies to the retaining section 154a being at the top of the connection seam 154.

As shown, the retaining section 154a is at the top of the arm rest support 34, such that the arm rest support 34 will move downwardly. However, the retaining section 154a could also be disposed on a lateral side or the bottom of the arm rest support 34, with corresponding pivoting movement. The selection of the location of the retaining section 154a may be made in accordance with the desired controlled pivoting movement of the arm rest support 34 (or the carrier plate 22 relative to the arm rest support 34) during a side impact event.

Due to the bending that occurs at the retaining section 154a, the retaining section 154a may also be considered or referred to as a living hinge. In this aspect, the retaining section 154a may have a thickness that is greater than the seam 154, but still less than the surrounding carrier plate structure, such that the arm rest support 34 and the carrier plate 22 may still bend relative to each other in a controlled manner in response to the thinner connection seam 154 breaking.

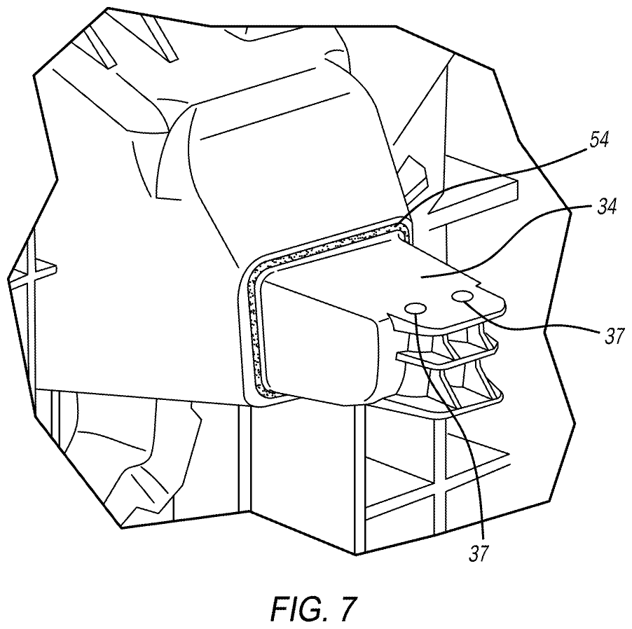

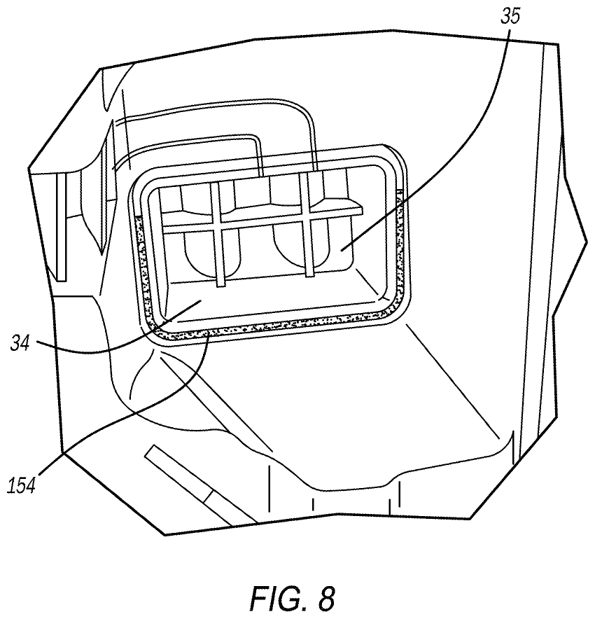

With reference to FIGS. 7 and 8, an embodiment having a single arm rest support 34 is shown, in which multiple mounting holes 37 are disposed on the arm rest support 34. In the other illustrated embodiment having two arm rest supports, each arm rest support 34 included a single mounting hole 37. It will be appreciated that other mounting hole arrangements may be used depending on the arrangement of the vehicle trim and vehicle door. In one aspect, the arm rest support 34 may immediately support the pull cup section of a vehicle trim component, with the bottom of the pull cup typically providing access to one of the fasteners for mounting the vehicle trim component. FIG. 7 illustrates the dry side and connection seam 54 (full closed loop), and FIG. 8 illustrates the wetside, and the partial connection seam 154. It will be appreciated that the full connection seam 34 of FIG. 7 could also apply to FIG. 8, and that the partial connection seam 154 of FIG. 8 could also apply to FIG. 7.

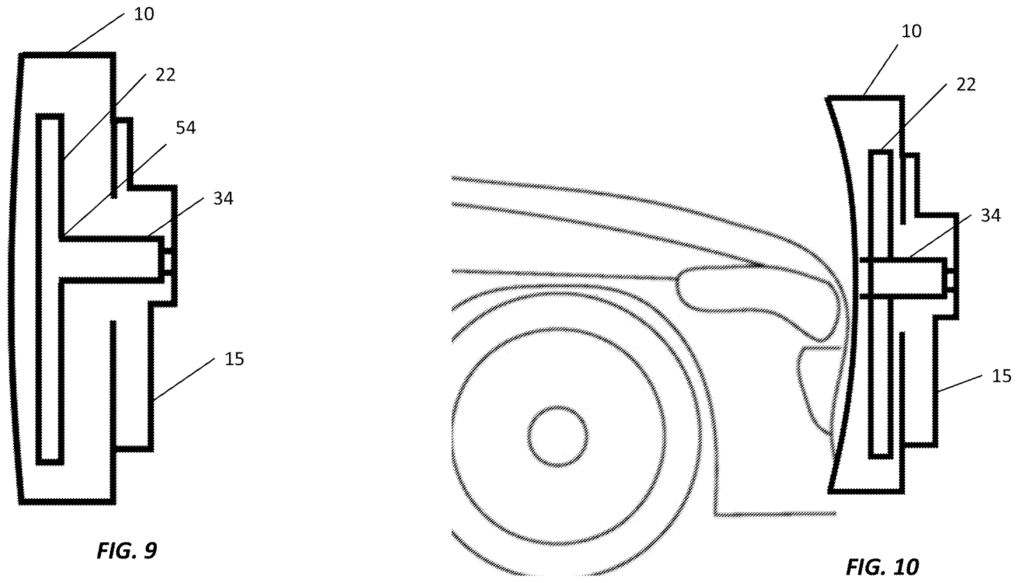

FIGS. 9 and 10 illustrate a schematic view of a vehicle door in cross-section, with the carrier plate 22 disposed therein and arm rest support 34 extending out from the carrier plate 22 toward the vehicle interior, with the arm rest support 34 attached to interior vehicle trim component 15. FIG. 10 illustrates the occurrence of a side impact event. As shown, a vehicle impacts the outer surface of the vehicle door 10, causing the outer door surface to collapse inwardly into contact with the carrier plate 22. Carrier plate 22 is shown shifted inwardly in response to the side impact. However, arm rest support 34 and trim component 15 are shown remaining in place, with the interface between the arm rest support 34 and the carrier plate 22 being broken, allowing relative movement therebetween. As shown, the left side of the arm rest support 34 in FIG. 10 is no longer connected to the carrier plate 22, with the carrier plate 22 shifted to the right.

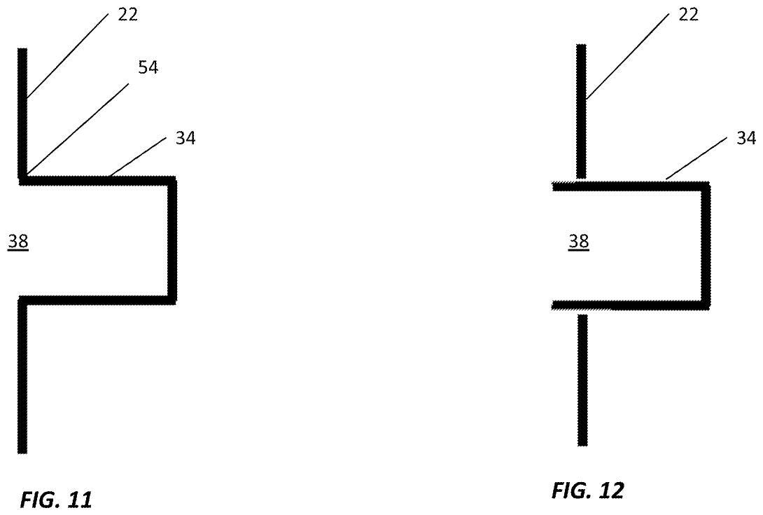

FIGS. 11 and 12 are an enlarged schematic illustration of the arm rest support 34 relative to the carrier plate 22, with connection seam 54 extending fully around the base of the arm rest support 34. In response to inward movement of the carrier plate 22, the arm rest 34 is completely severed (both at the top and bottom of the schematic view of FIG. 12).

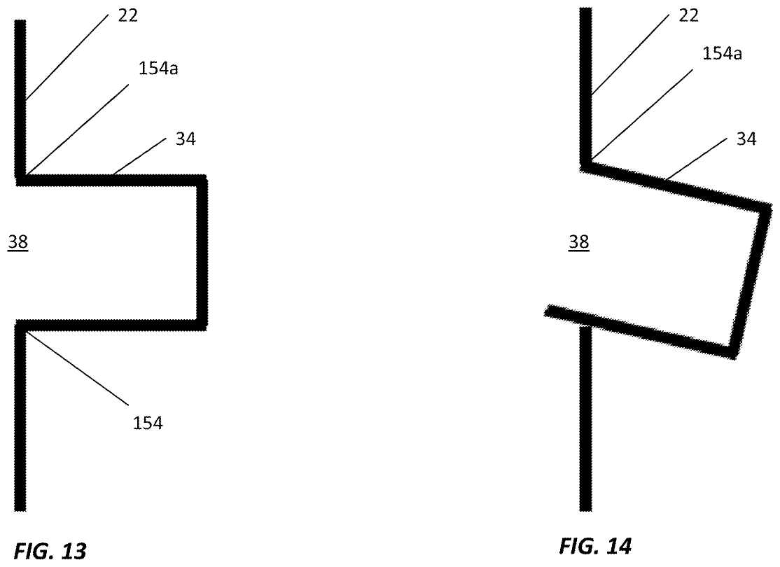

FIGS. 13 and 14 are another enlarged schematic illustration of the arm rest support 34 relative to the carrier plate 22, this time with partial seam 154 extending partially around the arm rest support 34 (for example on the lateral and bottom sides), and retaining section 154a extending across the upper side of the arm rest support 34. In response to a side impact, the arm rest support 34 partially severs relative to the carrier plate 22, and the arm rest support 34 pivots downward about the retaining section 154a, which maintains a connection between the arm rest support 34 and the carrier plate 22. Again, this pivoting between the arm rest support 34 and the carrier plate 22 is relative, and FIG. 14 thereby also illustrates a situation in which the arm rest support 34 remains stationary and the carrier plate 22 pivots relative to the stationary arm rest support 23. The retaining section 154a is shown at the top of FIG. 14, but could also be at other locations around the base of the arm rest support 34.

The opening between the carrier plate 22 and the arm rest support 34 that occurs in response to at least partially severing the connection therebetween may be referred to as an aperture 38 defined by the carrier plate 22. Accordingly, the arm rest support 34 extends inwardly from the aperture 38, and is configured to move at least partially into the aperture in response to an impact event, or to translate at least partially through the aperture. The arm rest support 34 moves into the aperture 38 whether complete or partial severance occurs, as illustrated in FIGS. 11-14.

The arm rest support 34, being an extension relative to the carrier plate 22 toward the vehicle interior, may also be referred to as an extension member. Indeed, the concepts described above are applicable to other support structure, and are not limited to arm rest supports. Other support structures that extend inwardly toward the vehicle relative to the carrier plate 22 or other similar structure may therefore also have a similar seam extending around at least a portion of the base of such an extension member, to allow for controlled severing between the extension member and the carrier plate 22. The seam may be a pre-formed area in the body of the carrier plate 22, such as an indentation, a fold, a bend, an area of reduced strength, and area of reduced weakness, a partially perforated area, as non-limiting examples, to facilitate severing first along the seam, before severing of the adjacent body of the carrier plate 22, as may occur when a crash load is applied to the carrier 22. The shape of the base of the extension member may also vary relative to the illustrated arm rest support 34. For example, the arm rest support 34 is shown to generally include four main sides. However, other support structures with fewer sides, such as a triangular base, or a greater number of sides, may be used. The selection of which portions of the interface between the base of the extension member, and the module from which it extends, may be selected to control the areas of the interface that sever and the relative movement that occurs between the module and the extension member during a side impact event.

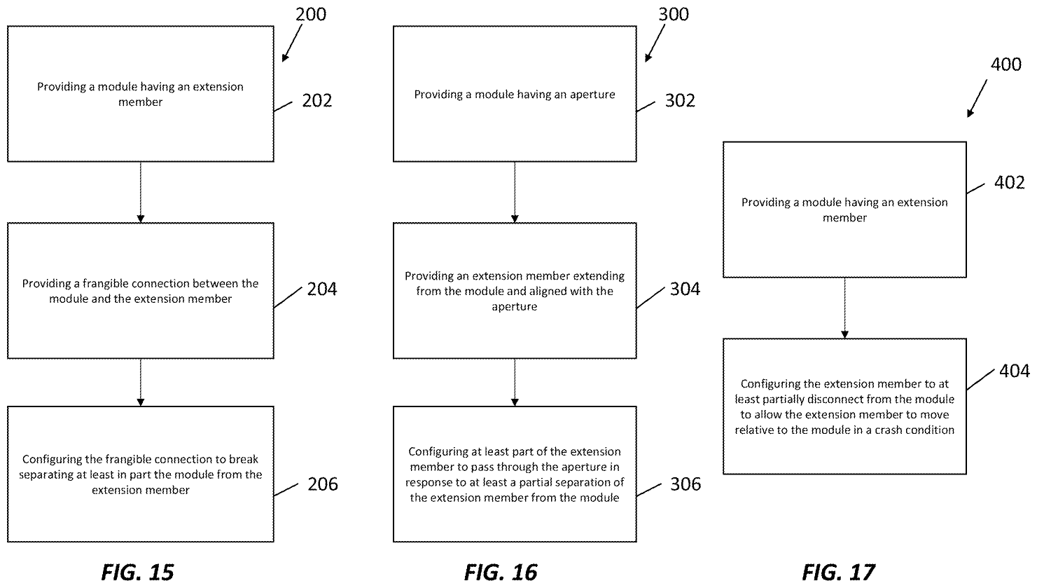

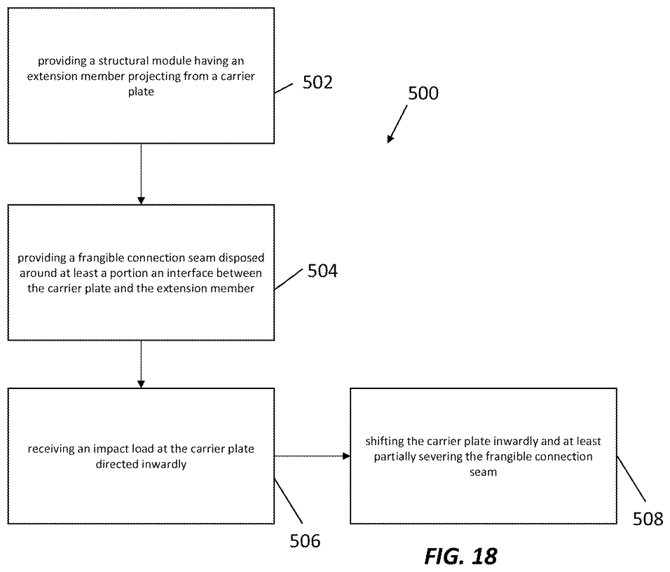

FIGS. 15-18 provide schematic illustrations of methods 200, 300, 400, and 500 associated with the above described module 20, which includes the carrier plate 22.

Method 200 includes the steps of: at step 202, Providing a module having an extension member; at step 204, Providing a frangible connection between the module and the extension member; and, at step 206, configuring the frangible connection to break, separating at least in part the module from the extension member.

Method 300 includes the steps of: at step 302, Providing a module having an aperture; at step 304, Providing an extension member extending from the module and aligned with the aperture; and, at step 306, Configuring at least part of the extension member to pass through the aperture in response to at least a partial separation of the extension member from the module.

Method 400 includes the steps of: at step 402, Providing a module having an extension member; and, at step 404, Configuring the extension member to at least partially disconnect from the module to allow the extension member to move relative to the module in a crash condition.

Method 500 includes the steps of: at step 502, providing a structural module having an extension member projecting from a carrier plate; at step 504, providing a frangible connection seam disposed around at least a portion an interface between the carrier plate and the extension member; at step 506, receiving an impact load at the carrier plate directed inwardly; and, at step 508, in response to receiving the impact load, shifting the carrier plate inwardly and at least partially severing the frangible connection seam.

The above-described embodiments of the invention are intended to be examples of the present invention and alterations and modifications may be effected thereto, by those of skill in the art, without departing from the spirit of the invention.

What is claimed is:

1. A structural door module for a motor vehicle closure panel, comprising,
a carrier plate including a dryside surface facing an interior of the motor vehicle and an opposed wetside surface facing an exterior of the motor vehicle;
a frangible connection seam extending across at least a portion of the carrier plate;
wherein the frangible connection seam severs relative to the carrier plate in response to an impact load exerted on the carrier plate.

2. The structural door module of claim 1, wherein the structural door module further comprises an extension member integrally formed with the carrier plate and projecting away from the carrier plate, wherein the frangible connection seam extends at least partially around an interface between the extension member and the carrier plate.

3. The structural door module of claim 2, wherein the connection seam extends fully around the interface, and the extension member separates fully from the carrier plate in response to the impact load.

4. The structural door module of claim 2, wherein the connection seam extends partially around the interface, and a retaining section of the interface extends between opposite ends of the connection seam, and the extension member separates partially from the carrier plate and pivots about the retaining section relative to the carrier plate in response to the impact load.

5. The structural door module of claim 2, wherein the connection seam is defined by a reduced material thickness relative to the carrier plate.

6. The structural door module of claim 2, wherein the connection seam defines a flat interface that is orthogonal to the impact load when the impact load is directed toward the interior of the vehicle.

7. The structural door module of claim 4, wherein the retaining section is disposed along an upper edge of the extension member and the connections seam extends along a bottom edge and lateral edges of the extension member.

8. The structural door module of claim 4, wherein the connection seam has a reduced material thickness relative to the retaining section.

9. The structural door module of claim 2, wherein the extension member includes two arm rest supports each having the connection seam.

10. The structural door module of claim 2, wherein the extension member is configured to retain its shape in response to severing the connection seam, wherein the carrier plate moves inwardly relative to the retained shape of the extension member in response to the impact load.

11. A method of limiting inward intrusion by a structural module of a vehicle closure panel during a side impact, the method including the steps of:
providing a structural module having an extension member integrally formed with and projecting from a carrier plate;
providing a frangible connection seam disposed around at least a portion of an interface between the carrier plate and the extension member;
receiving an impact load at the carrier plate directed inwardly;
in response to receiving the impact load, shifting the carrier plate inwardly and at least partially severing the frangible connection seam.

12. The method of claim 11, further comprising maintaining a connection between the extension member and the carrier plate along a retaining section therebetween in response to shifting the carrier plate inwardly.

13. The method of claim 12, wherein the frangible connection seam extends around the interface and includes first and second ends, wherein the retaining section extends between the first and second ends, wherein the extension member bends relative to the carrier plate about the retaining section in response to the carrier plate shifting inwardly.

14. The method of claim 11, wherein the frangible connection seam defines a closed loop around the interface, the method including fully severing the extension member relative to the carrier plate in response to shifting the carrier plate inwardly.

15. The method of claim 11, wherein at least a portion of the extension member remains attached to an interior trim component in response to the carrier plate shifting inwardly.

16. The method of claim 11, wherein the carrier plate defines an aperture, wherein the extension member encloses the aperture prior to receiving the impact load, wherein at least a portion of the extension member translates through the aperture in response to receiving the impact load.

17. The method of claim 11, further comprising severing a reduced material thickness along the connection seam in response to receiving the impact load, wherein the extension member shifts relative to the carrier plate in areas corresponding to the reduced material thickness.

18. A structural door module for a motor vehicle closure panel, comprising:
a carrier plate including a dryside surface facing an interior of the motor vehicle and an opposed wetside surface facing an exterior of the motor vehicle;
an extension member integrally formed with the carrier plate and projecting outwardly from the carrier plate and toward a passenger compartment of the motor vehicle;
an aperture formed in the carrier plate and enclosed by the extension member along an interface between the extension member and the carrier plate;
wherein at least a portion of the interface has a reduced material thickness relative to the carrier plate;
wherein the extension member severs relative to the carrier plate along the reduced material thickness of the interface in response to an inwardly directed impact load exerted on the carrier plate.

19. The structural door module of claim 18, wherein the reduced material thickness extends fully around the interface to define a closed loop, wherein the extension member fully severs relative to the carrier plate.

20. The structural door module of claim 18, wherein the reduced material thickness extends along a first portion of the interface, and a retaining section extends along a second portion of the interface, wherein the second portion of the interface has a greater thickness than the first portion of the interface, wherein the first portion severs and the second portion retains the extension member to the carrier plate in response to the impact load.
